(19) United States
(12) Patent Application Publication
(10) Pub. No.: US 2009/0255178 A1
(43) Pub. Date: Oct. 15, 2009

(54) PLANT PAIL

(76) Inventors: Daniel Barbalho, Atlanta, GA (US); Sean T. Ogburn, Hoschton, GA (US)

Correspondence Address: CARLSON, GASKEY & OLDS, P.C., 400 WEST MAPLE ROAD, SUITE 350, BIRMINGHAM, MI, 48009, US

(21) Appl. No.: 12/102,833

(22) Filed: Apr. 14, 2008

(51) Int. Cl. A01G 9/02

(52) U.S. Cl. 47/66.1; 47/84

(57) ABSTRACT

A plant pail includes a base and a wall extending upwardly from a periphery of the base. The wall includes an upper portion defining a mouth of the container and a body portion below the upper portion. The upper portion includes opposite portions of increased width, such that the opposite portions protrude outwardly relative to the body portion, thereby defining upper handles.

### BACKGROUND OF THE INVENTION

Each year, millions of plants are shipped, stored and sold in plastics pails. The pails typically have a round base and a wall extending upwardly from the periphery of the base. Soil and/or media fill the pail and the roots of the plant are grown in the soil or other media.

The current pails are difficult to carry and cumbersome to move. It is also sometimes difficult to remove the plant from the pail without damaging the plant. Often, the user cuts the wall of the pail to facilitate removal of the plant.

### SUMMARY OF THE INVENTION

The present invention provides a container, such as a plant pail, which is particularly useful for growing, storing and transporting plants. The pail includes a base and a wall extending upwardly from a periphery of the base. The wall includes an upper portion defining a mouth of the pail and a body portion below the upper portion. The upper portion includes opposite portions of increased width, such that the opposite portions protrude outwardly relative to the body portion therebelow, thereby defining upper handles.

In another feature of the present invention, the wall further includes a lower portion having opposite portions of a reduced width, thereby defining lower handles below the body portion. In this manner, the user can more easily lift the pail from the floor using the lower handles and then carry the pail using either the upper or lower handles.

In another feature of the present invention, the wall includes a tear portion in the upper portion and in the body portion, such that the user can create a slit through the pail without the use of tools (or can do so more easily with the use of tools) in order to remove the plant from the pail.

These and other features of the application can be best understood from the following specification and drawings, the following of which is a brief description.

### BRIEF DESCRIPTION OF THE DRAWINGS

FIG. 1 is a perspective view of a plant pail according to one embodiment of the present invention.

FIG. 2 is a bottom perspective view of the plant pail of FIG. 1.

FIG. 3 is a top view of the plant pail of FIG. 1.

FIG. 4 is a section view taken along line 4-4 of FIG. 3.

FIG. 5 is a section view taken along line 5-5 of FIG. 3.

FIG. 6 is a side view of the pail of FIG. 1.

FIG. 7 is a different side view of the pail of FIG. 1.

FIG. 8 illustrates the pail of FIG. 1 with a similar pail nested therein.

FIG. 9 illustrates the pail of FIG. 1 with an optional tear portion formed in the wall.

FIG. 10 illustrates the pail of FIG. 9 holding dirt and a plant.

### DETAILED DESCRIPTION OF THE PREFERRED EMBODIMENT

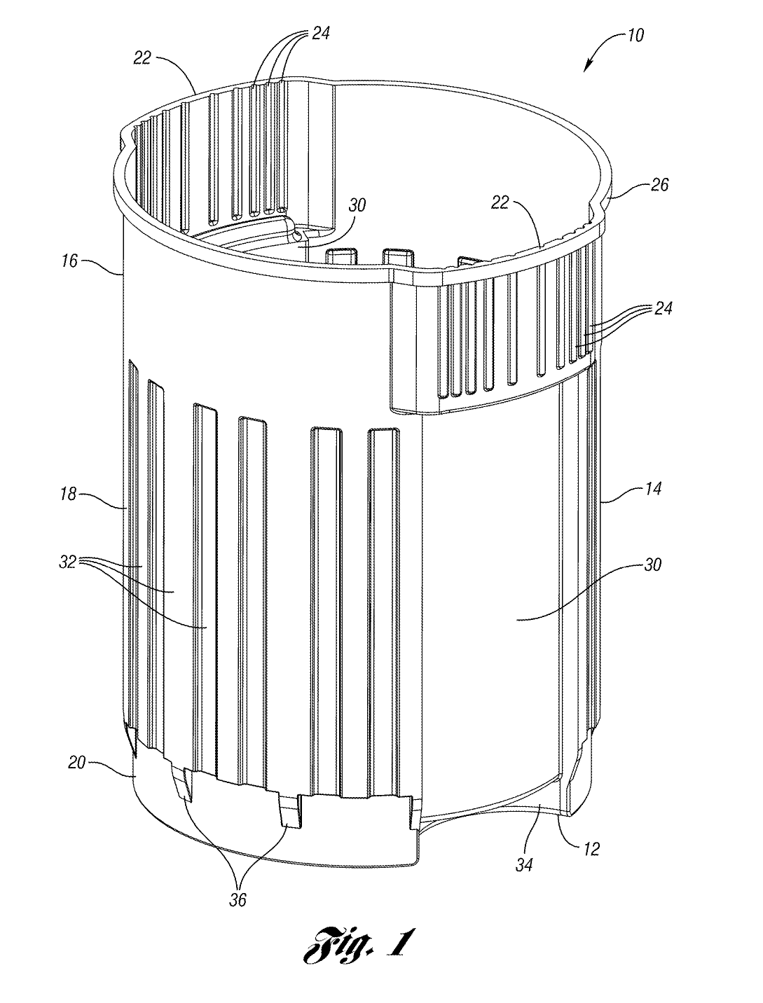

A container that can be used as a plant pail 10 is shown in FIG. 1. The plant pail 10 includes a base 12 and a wall 14 extending upwardly from the periphery of the base 12. The wall 14 is generally cylindrical and includes an upper portion 16, a body portion 18 below the upper portion 16, and a lower portion 20 below the body portion 18. The upper portion 16 includes opposite portions 22 of increased width, or in this particular example, increased radius. The opposite portions 22 have vertical corrugations 24 or ribs formed therein to increase strength. The upper most edge of the upper portion 16, including the opposite portions 22, has a lip 26 protruding outwardly and then downwardly therefrom. The opposite portions 22 protrude outwardly relative to the body portion 18.

The body portion 18 also includes a pair of opposite portions 30, aligned with the opposite portions 22 of the upper portion 16. The opposite portions 30 of the body portion 18 have a reduced width (or reduced diameter) relative to the remainder of the body portion 18. Thus, the opposite portions 22 of the upper portion 16 protrude outwardly relative to the opposite portions 30 of the body portion 18 directly therebelow to define upper handles.

The opposite portions 30 of the body portion 18 are generally convex and smooth, while the remainder of the body portion 18 has a plurality of vertical corrugations 32 formed therein.

The lower portion 20 of the wall 14 has a width or radius that is slightly greater than that of the opposite portions 30 of the body portion 18 and slightly less than that of the remainder of the body portion 18, including the corrugations 32. The lower portion 20 further includes opposite portions 34, aligned with the opposite portions 22, 30 of the upper portion 16 and body portion 18, respectively. The opposite portions 34 of the lower portion 20 have a concave exterior surface, such that they protrude inwardly into the plant pail 10.

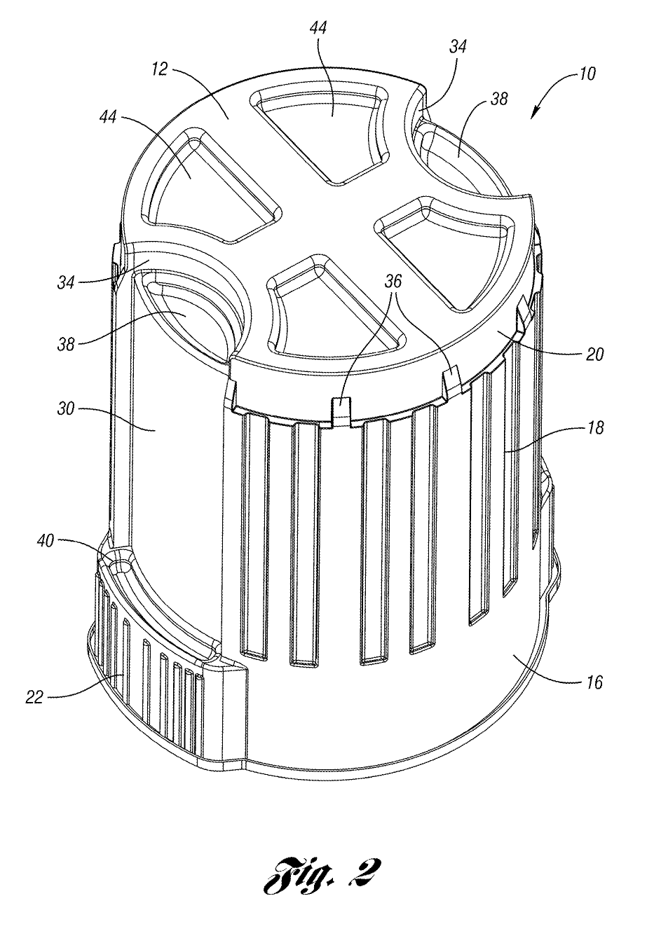

This is more easily seen in FIG. 2, which is a bottom perspective view of the plant pail 10. The opposite portions 34 of the lower portion 20 are connected to the base 12. Recessed, generally horizontal walls 38 are between the opposite portions 30 and the opposite portions 34 to define lower handles. The horizontal walls 38 are recessed to provide finger recesses. Similarly, generally horizontal walls 40 connect the opposite portions 22 to the opposite portions 30 and are recessed to provide a finger recess to the upper handles defined thereby. Gussets 36 connect the body portion 18 to the lower portion 20 for reinforcement. The base 12 includes a plurality of raised portions 44 to increase the strength and stiffness of the base 12.

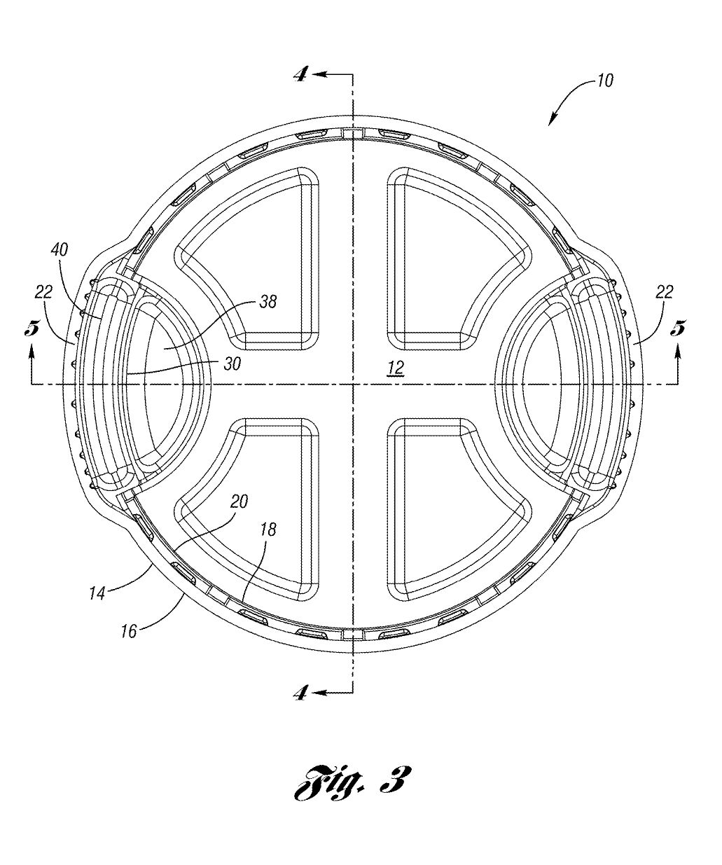

FIG. 3 is a top view of the plant pail 10. As shown, the opposite portions 30 are spaced inwardly of the lower portion 20, which is spaced inwardly of the body portion 18.

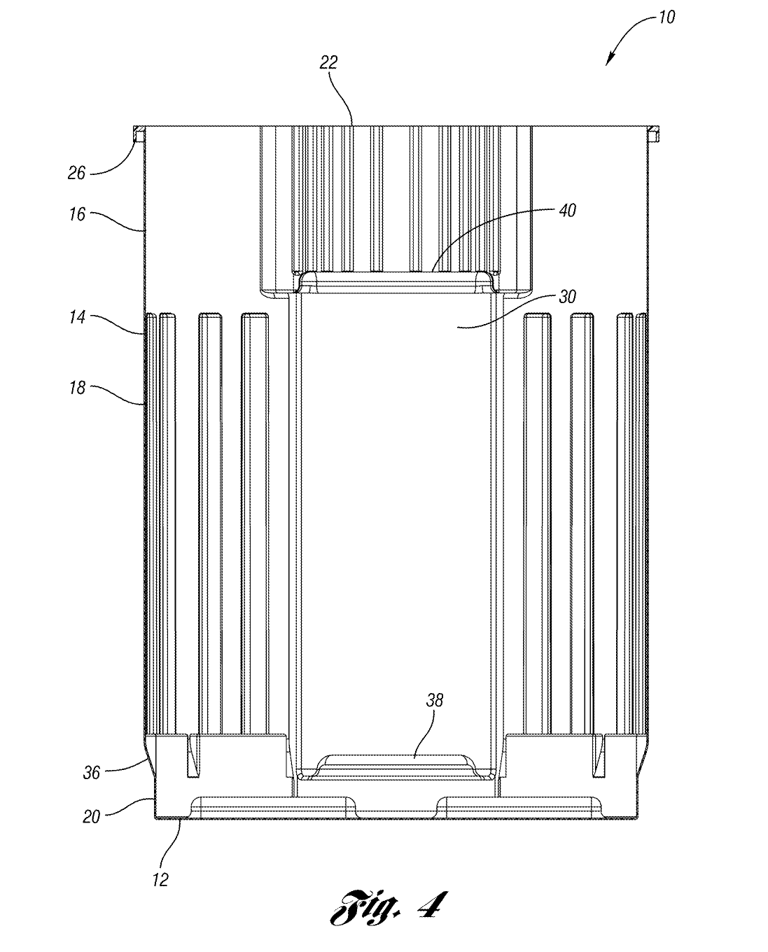

FIG. 4 is a section view taken along line 4-4 of FIG. 3. As shown, the lower portion 20 (including but not limited to the opposite portions 34) is spaced inwardly of the body portion 18 in the upper portion 16.

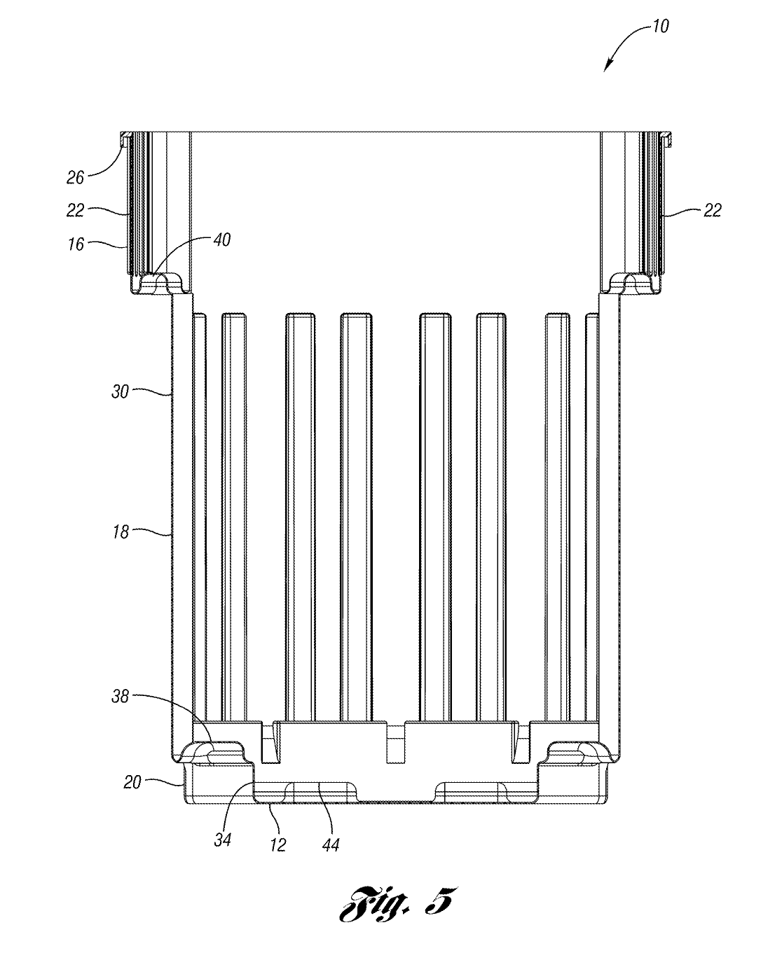

FIG. 5 is a section view taken along line 5-5 of FIG. 3. The upper handles defined by the opposite portions 22 and walls 40 are shown. The lower handles are defined in the recess between the wall 38, opposite portion 34, inwardly of the remainder of the lower portion 20. Thus, when the plant pail 10 is resting on the floor, a user can lift the plant pail 10 by the lower handles 38 or the upper handles 40.

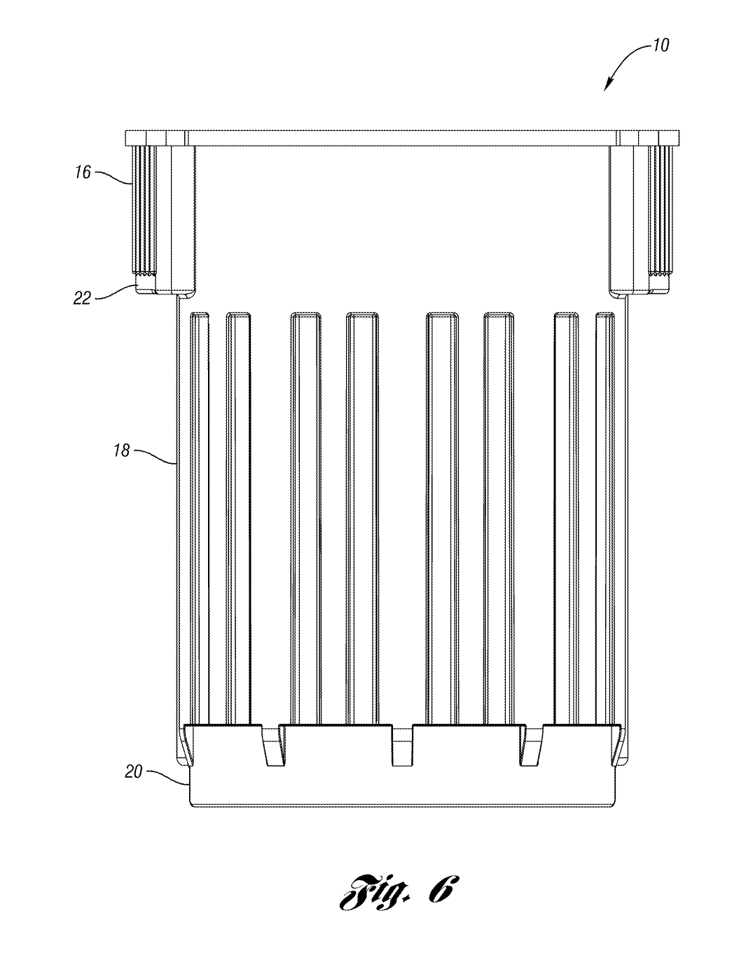

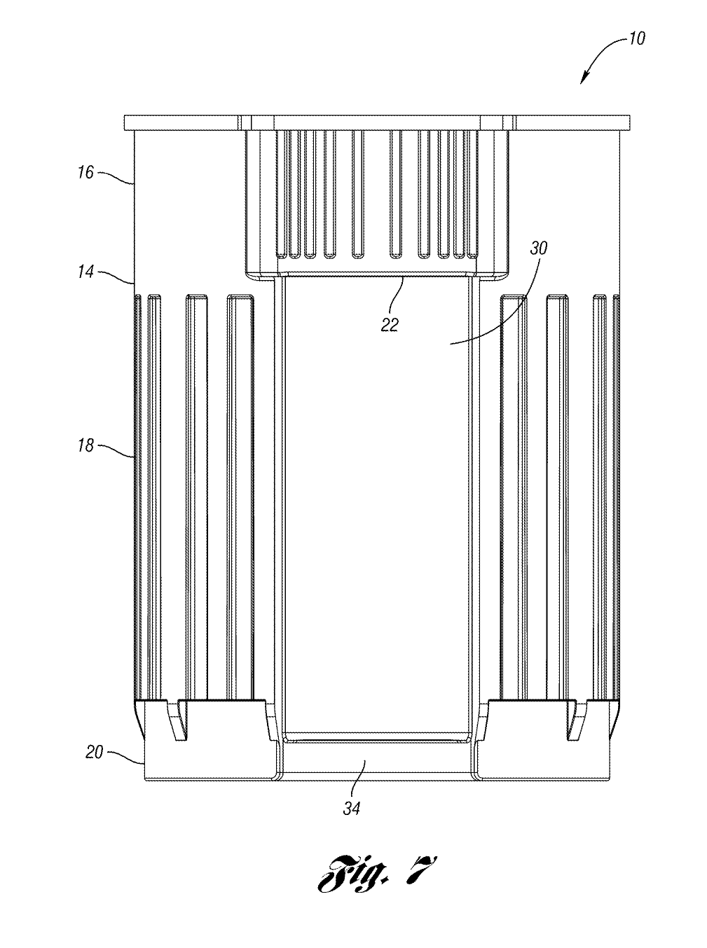

FIGS. 6 and 7 are different side views of the plant pail 10.

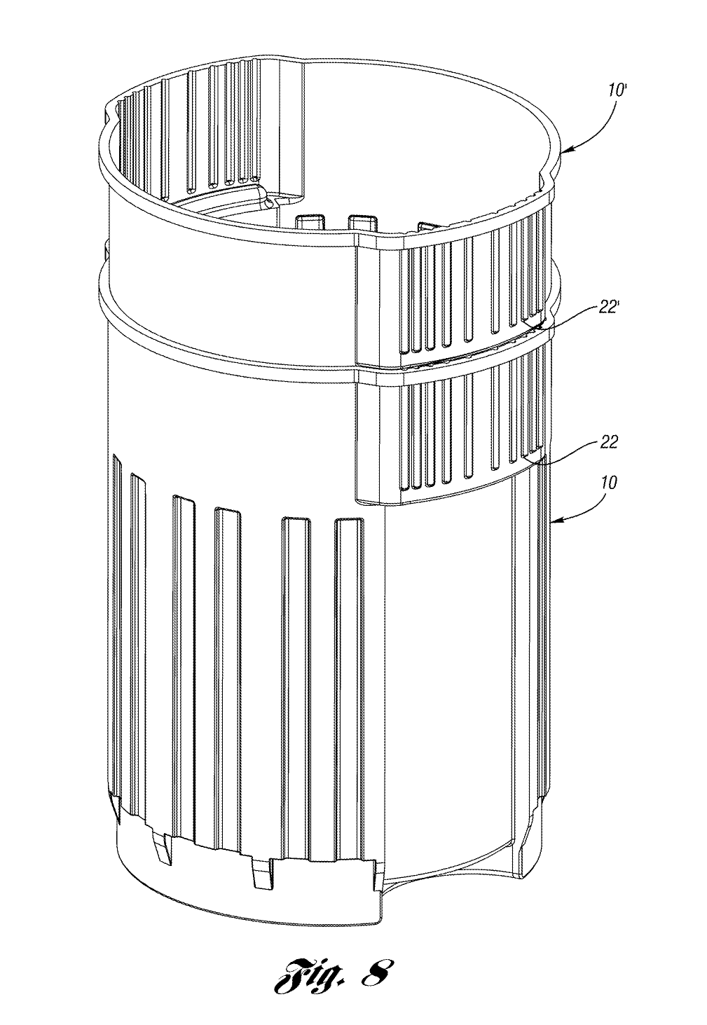

FIG. 8 illustrates the plant pail 10 with a similar plant pail 10′ nested therein. When empty, the plant pail 10′ can be received within the lower plant pail 10 until the opposite portions 22′ of the upper pail 10′ rest on the opposite portions 22 of the lower plant pail 10. This reduces the space necessary to store and transport empty plant pails 10.

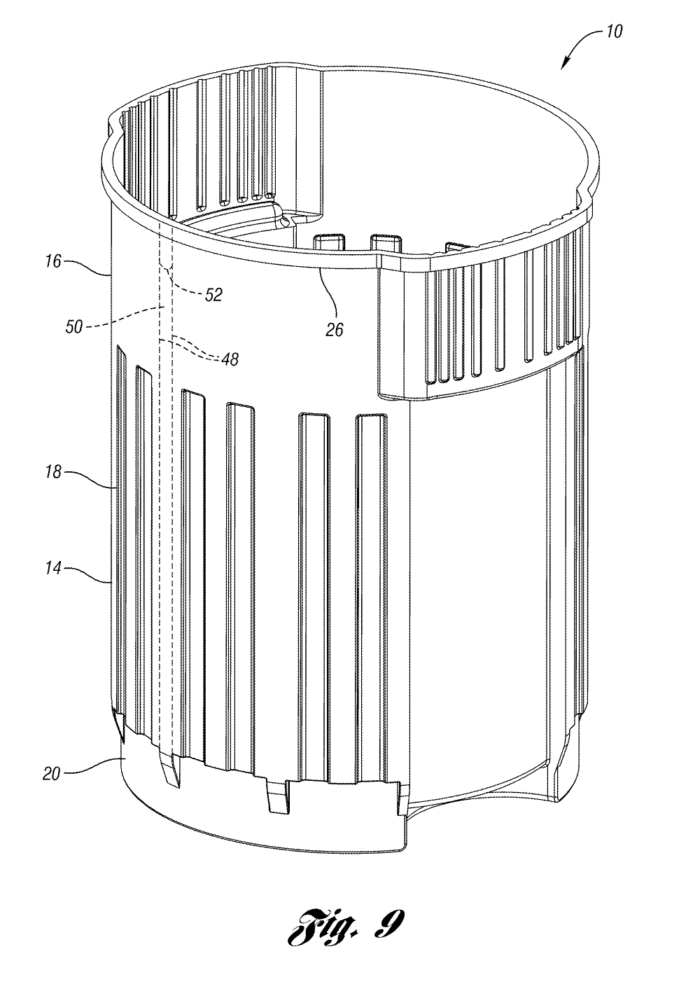

FIG. 9 illustrates the plant pail 10 with an optional tear portion formed therein. The tear portion provides a way for a user to easily form a slit through the upper portion 16 (including the lip 26) and at least a substantial portion of the body portion 18, for easier removal of the plant and soil stored in the plant pail 10. In the example shown, the tear portion includes spaced apart vertical tear seams 48 defining a tear strip 50 therebetween. The tear seams 48 may be spaced apart perforations, or spaced apart or continuous weakened or thinner portions in the wall 14. The tear seams 48 may continue through the upper most edges of the upper portion 16, including the lip 26. A pull-tab 52, integral with the lip 26, and extending downwardly from the lip 26 may be provided at an end of the tear strip 50 to facilitate tearing of the tear strip 50 from the wall 14 along the tear seams 48 to facilitate removal of the soil and plant from the plant pail 10.

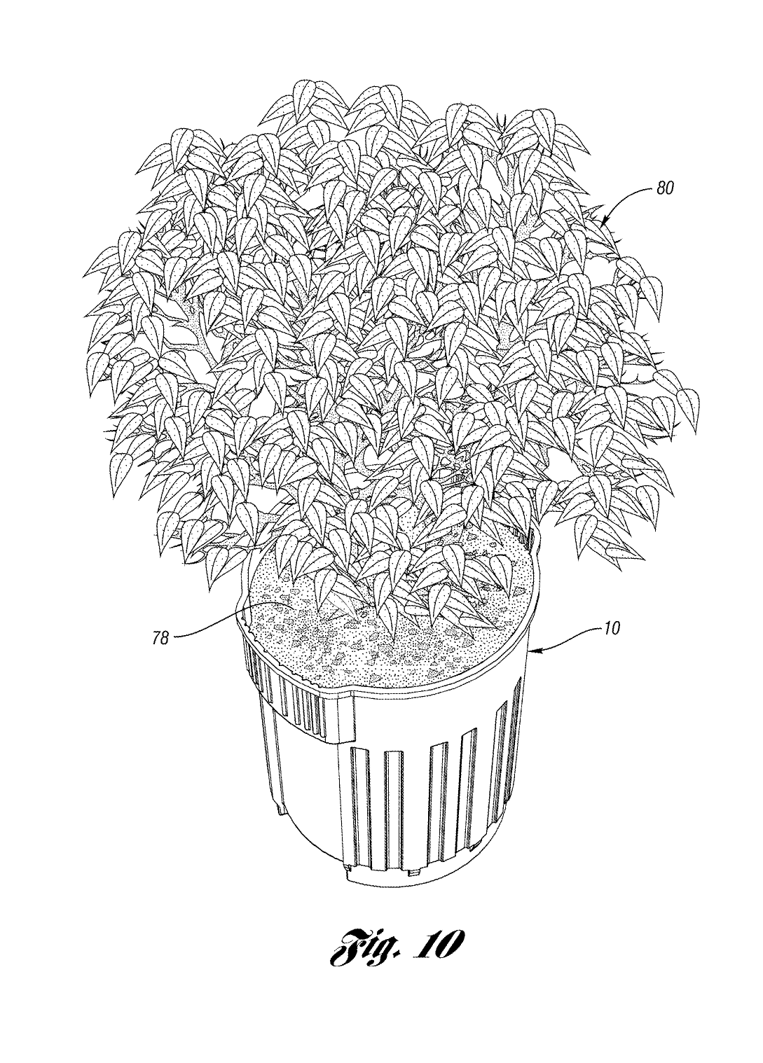

FIG. 10 illustrates the plant pail 10 with soil 78 or other media stored therein and with a plant 80 planted in the soil 78. The plant 80 grows in the soil 78. The plant 80, soil 78 and plant pail 10 are shipped to stores for resale (for example). Purchasers can easily lift the plant pail 10, soil 78 and plant 80 utilizing either the upper handles or lower handles. When the user is ready to plant the plant 80, the user pulls the pull-tab 52 to tear the tear seam 50 to split the side wall 14, facilitating removal of the plant 80 and soil 78 intact from the plant pail 10. The plant pail 10 can then be recycled.

The base 12 and wall 14 in this example are injection molded as a single, integral unit of polypropylene or other suitable material, but other methods and materials could be used. Drain holes could be added for appropriate applications.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, the pail 10 need not be generally cylindrical, but could have a rectangular or square or other cross-section. Further, although the container has been described as being used for a plant pail, it could be used for other purposes.

What is claimed is:

1) A container comprising:
a base; and
a wall extending upwardly from a periphery of the base, the wall including an upper portion defining a mouth of the container and a body portion below the upper portion, the upper portion including opposite portions of increased width, the opposite portions protruding outwardly relative to the body portion therebelow thereby defining upper handles.

2) The container of claim 1 wherein the handles each include a finger recess on an underside.

3) The container of claim 1 further including a lip protruding outwardly and then downwardly from uppermost edges of the upper portion of the wall, including the opposite portions.

4) The container of claim 1 wherein the body portion includes opposite portions of reduced width below the opposite portions of the upper portion.

5) The container of claim 4 wherein the wall further includes a lower portion below the body portion, the lower portion including opposite portions of reduced width below the opposite portions of the body portion to define lower handles on undersides of the opposite portions of the body portions.

6) The container of claim 5 wherein the lower handles each includes a finger recess on an underside.

7) The container of claim 6 wherein the opposite portions of the upper portion have a radius larger than the upper portion other than the opposite portions.

8) The container of claim 7 wherein the opposite portions of the body portion have a radius larger than the body portion other than the opposite portions.

9) The container of claim 8 wherein the opposite portions of the lower portion have concave exterior surfaces such that the opposite portions of the lower portion protrude inwardly into the container.

10) The container of claim 9 wherein the lower portion, including the opposite portions thereof, is connected to the base.

11) The container of claim 10 wherein the body portion other than the opposite portions thereof have a plurality of vertical corrugations.

12) The container of claim 10 wherein the lower portion other than the opposite portions thereof has a width less than that of the body portion.

13) The container of claim 1 wherein the opposite portions of the upper portion include vertical corrugations formed therein.

14) The container of claim 1 wherein the wall includes a tear portion in the upper portion and in the body portion.

15) The container of claim 14 wherein the tear portion includes at least one tear seam in the upper portion and the body portion and through a lip at an uppermost edge of the upper portion.

16) A container comprising:
a base;
a wall extending upwardly from a periphery of the base, the wall including an upper portion defining a mouth of the container and a body portion below the upper portion; and
a tear portion formed in the upper portion and the body portion.

17) The container of claim 16 wherein the tear portion includes at least one tear seam in the upper portion and the body portion and through a lip at an uppermost edge of the upper portion.

18) The container of claim 17 wherein the upper portion includes at least one portion of increased width, the at least one portion protruding outwardly relative to the body portion therebelow thereby defining at least one upper handle.

19) A container comprising:
a base; and
a wall extending upwardly from a periphery of the base, the wall including an upper portion defining a mouth of the container, a body portion below the upper portion, and a lower portion below the body portion, the lower portion including opposite portions of reduced width, the opposite portions protruding inwardly below opposite portions of the body portion to define lower handles on undersides of the opposite portions of the body portion.

20) The container of claim 19 wherein the lower handles each includes a finger recess on an underside.
